(19) United States
(12) Patent Application Publication
(10) Pub. No.: US 2012/0027926 A1
(43) Pub. Date: Feb. 2, 2012

(54) REFERENCE ELECTRODE, ITS MANUFACTURING METHOD, AND AN ELECTROCHEMICAL CELL

(75) Inventors: Takuhiro Miyuki, Osaka (JP); Takashi Mukai, Osaka (JP); Tetsuo Sakai, Osaka (JP); Yukio Yamakawa, Osaka (JP); Yoshiyuki Honjo, Hyogo (JP); Hironori Yamasaki, Osaka (JP)

(73) Assignees: Honjo Metal Co., Ltd., Osaka (JP); National Institute of Advanced Industrial Science and Technology, Tokyo (JP)

(21) Appl. No.: 13/193,439

(22) Filed: Jul. 28, 2011

(30) Foreign Application Priority Data
Jul. 30, 2010 (JP) 2010-171430

(51) Int. Cl. B05D 5/12; C25D 3/42; C25D 7/06; C25D 3/56

(52) U.S. Cl. 427/78; 205/238; 205/261; 205/149

(57) ABSTRACT

[PROBLEM] The purpose of the present invention is to provide a reference electrode which is easy to manufacture and handle, its manufacturing method, and an electrochemical cell using this.

[METHOD FOR SOLVING THE PROBLEM] The reference electrode 10 comprises a core material 11 extending parallel to the anode 14 or the cathode 16 from a terminal, a lithium membrane 12 coating from a tip of the core material 11 to a field with predetermined length, and an insulator 13 partially coating a field uncoated with the lithium membrane 12 on the core material 11. The material consisting of at least a surface of the core material 11 is a conductive material which is substantially unresponsive to lithium or lithium alloy. The maximum width in a cross section of the core material 11 is preferably in the range of not less than 5 micrometers but not more than 50 micrometers, and thickness of the lithium membrane is preferably in the range of not less than 0.1 micrometers but not more than 20 micrometers. By using the core material 11 with higher rigidity than lithium or lithium alloy, handling and manufacturing the reference material 10 is easy, for example, the material can be processed easily and its shape can be stabilized.

[SELECTED FIGURE] FIG. 2

### CROSS-REFERENCE TO RELATED APPLICATIONS

This Application claims the benefit of Japanese Patent Application No. 2010-171430, filed Jul. 30, 2010, under 35 U.S.C. 119 and the Paris Convention; which is hereby incorporated by reference in its entirety.

### TECHNICAL FIELD

A present invention has a working pole (anode) and a counter pole (cathode), and the invention relates to those that cause battery change between electrodes by an electrochemical reaction, for example, a reference electrode to measure some electric characteristics in a lithium battery, its manufacturing method, and an electrochemical cell with the reference electrode.

### BACKGROUND OF THE INVENTION

Charge of a rechargeable battery is a process in which a voltage is applied to the rechargeable battery so that potential difference between an anode pole and a cathode pole is recovered in a predetermined size. During charge of a lithium rechargeable battery, unlike other rechargeable batteries, overcharge causes metallic lithium (so called a lithium dendrite) to dendritically separate out at the cathode. When the lithium dendrite deposits at the cathode, there was a possibility of lowering cycle life due to a decrease in charge efficiency and of decreasing its reliability by a short circuit between the anode-cathode through the lithium dendrite which breaks through a separator. Therefore, the upper limit of a recovery electromotive voltage by the charge is conventionally regarded as 4.0-4.3 V in order to avoid the above-mentioned problems.

Deposit of the lithium dendrite at the cathode occurs when a potential to the lithium-ion of the cathode, i.e., a counterion potential becomes 0v or less. In a cathode of the original lithium rechargeable battery shipped from a production plant, a potential of its counter lithium-ion is set up to be about 1V, but is known to be gradually lowered because of discharge and charge of the battery. Therefore, in a used lithium rechargeable battery, a potential of the counter lithium-ion at its cathode is lowered than that in a new state, further decreases by insertion of the lithium-ion to the cathode during the charge, and becomes 0V or less to cause deposit of metallic lithium. Therefore, in order to avoid the deposit of lithium dendrite, it is preferred to measure potential of a lithium-ion at a cathode during the charge and to always control and hold the potential at a proper level.

Then, various proposals for controlling potential of a counter lithium-ion in a rechargeable battery have been made. For instance, Japanese laid-open publication H11-67280 describes a three-electrode cell comprising not only a working pole (anode) and a counter pole (cathode), but also a reference electrode consisting of lithium or a lithium alloy, wherein charge is completed before a potential difference between the cathode and the reference electrode is lowered to the potential difference that causes deposit of metallic lithium at the cathode (refer to a paragraph [0006] of this document). Japanese laid-open publication 2002-50407 describes that a three-electrode cell is constituted to have its terminal attached to polar plates of the anode or the cathode, wherein potential of the polar plates is directly measured by each terminals to control charge and discharge (refer to a paragraph [0012] of this document). Japanese laid-open publication 2005-019116 describes a four-electrode cell structure with an anode reference electrode and a cathode reference electrode placed adjacent to an anode and a cathode, respectively, wherein charge and discharge is controlled based on potential difference between the anode reference electrode-the anode, the cathode reference electrode-the anode, the anode reference electrode-the cathode, and the cathode reference electrode-the cathode, respectively (refer to a paragraph [0014] of this document). Japanese laid-open publication 2006-179329 describes that employing the same four-electrode cell structure as described in JP 2005-019116 leads to obtaining information such as a potential gradient produced between a working pole (anode) and a counter pole (cathode) at the time of charge and discharge (refer to paragraph [0013]-[0014] of this document).

### Problem(s) to be Solved by the Invention

However, each of the above-mentioned prior arts has following disadvantages. Regarding a three-electrode type lithium rechargeable battery with a three-electrode cell of JP H11-67280 and 2002-50407, even if a potential difference between anode-reference electrode is measured to check potential of anode alone, it is unable to accurately determine the potential of anode alone, since the difference is affected by cathode due to potential gradient inside a battery. Similarly, even if a potential difference between cathode-reference electrodes is measured to check potential of cathode alone, it is unable to accurately determine the potential of cathode alone, since the difference is affected by anode due to potential gradient inside a battery. As a result, strict charge control cannot be performed and therefore, there is a possibility that a lithium dendrite may deposit at the cathode. Additionally, regarding the three-electrode lithium rechargeable battery, the information about the electrode potential in the low-rate charge and discharge of one to ten hour rates (0.1C rate-1C rate) is only acquired, and it is unable to accurately grasp the state of a potential gradient and resistance of an electrolyte that are produced between the working pole-counter pole. Therefore, it was difficult to gain high charge efficiency and high credibility.

On the other hand, regarding a four-electrode rechargeable battery with four-electrode cells of JP 2005-019116 and 2006-179329, it is possible to more accurately determine potentials of a working pole alone and a counter pole alone, and thus enable to resolve the above-mentioned problems to some extent.

However, in case that any of the above-mentioned conventional three-electrode cell and four-electrode cell is employed, it took tremendous time and effort to handle and create a reference electrode in a cell. In particular, a cell structure with several reference electrodes is expensive to manufacture and thus it is difficult to put it into practice.

The purpose of the present invention is to provide a reference electrode which is easy to manufacture and handle by improving the structure thereof, its manufacturing method, and an electrochemical cell using this.

### SUMMARY OF THE INVENTION

A reference electrode of the present invention is a reference electrode arranged between a working pole and a counter pole in an electrochemical cell. The reference electrode has a core material and a lithium membrane consisting of lithium or a lithium alloy which covers at least in part of the core material. Furthermore, at least a surface of the core material is a conductive material which is substantially unresponsive to the lithium or the lithium alloy. Here, the term “substantially unresponsive” includes not only the case that the material do not respond at all, but also the case that normal function of the lithium membrane can be maintained while the reference electrode is used, even if the material slightly responds. For example, a case is included therein, wherein a barrier substance is formed to prevent a reaction to proceed. The core material is not required to entirely consist of a same material. For example, a central part of the core material may be an insulator such as ceramics, and its circumference (surface) may be plated with metal. The conductive material may not be limited to metal and may be inorganic substances, such as glass and carbon.

According to the present invention, it is possible to more accurately grasp a potential of a working pole and a counter pole using a reference electrode with superior shape stability and simultaneously to grasp a resistance of the working pole, the counter pole, a separator, and an electrolyte. Furthermore, since the reference electrode comprises a core material used as a base of a lithium membrane, it is easier to handle and manufacture the reference electrode as compared to a reference electrode consisting of only lithium or a lithium alloy (hereinafter, referred to as lithium etc.). Compared with other metallic elements, lithium (including a lithium alloy primarily consisting of lithium) is very soft and adhesive, and therefore lithium is difficult to precisely process and lacks shape stability in production of a reference electrode. In contrast, if a kind of material of a core material is suitably chosen, the core material can be processed easily and the shape stability would be also satisfactory. And then, it becomes possible to easily manufacture a reference electrode by coating surface of the core material with lithium or a lithium alloy using a conventional means such as vapor deposition and electroplating. The lithium or the lithium alloy alone is soft and deformable and thus is difficult to handle after the manufacture, but choosing a kind of material of the core material which has higher rigidity than lithium etc. makes its handling easy after the manufacture. Since lithium membrane covers outer perimeter of the core material in a closed-circular pattern, the elasticity of connected lithium membrane comes to work and the lithium membrane becomes difficult to exfoliate.

According to experiments by the present inventors, it was found that a maximum width in a cross section of the core material was preferably in the range of not less than 5 micrometers but not more than 50 micrometers. The reason is explained below. “A maximum width in a cross section of the core material” is a size of a diameter when the cross section is, for example, circular and is a size of a diagonal line when the cross section is rectangle, square, and polygon. If the maximum width in a cross section of the core material is too small, there is a possibility that the core material may be disconnected at the time of connection with a terminal since mechanical strength of the core material is insufficient. Furthermore, when the core material is hold at one end, it may be disconnected for weight of the lithium membrane covering the surface of the core material. Additionally, if the maximum width in a cross section of the core material is small, its conductivity lowers and it is difficult to uniformly form metallic lithium by an electroplating method and a vacuum evaporation method as explained below. On the other hand, when the maximum width is too large, there is a possibility that lithium membrane may easily exfoliate and thus stable voltage and resistance may become difficult to obtain. This is associated with curvature of a graphic showing an outline in a cross section of the core material. For example, if the maximum width of the core material is in an appropriate range, the curvature of the lithium membrane is large in a circumferential direction, which avoids the distortion. That is, the lithium membrane formed on the core material tends to connect each other to be in the form of a closed ring. For this reason, as mentioned above, elasticity of the closed ring-like lithium membrane works effectively, and lithium membrane is difficult to exfoliate. However, if the maximum width in a cross section of the core material is too large, the curvature in the circumferential direction is small, and therefore shape of the core material in the circumferential direction comes close to flat and shape of the covered lithium membrane also comes close to flat. As a result, the lithium membrane is subject to distortion and is less likely to be in the form of a closed ring due to exfoliation from the core material and thus to have uniform thickness. If the maximum width in a cross section of a reference electrode is too large, it disturbs a surrounding electric field of an electrode (a working pole or a counter pole) to be measured. Therefore, potential of the electrode cannot be measured correctly. Additionally, if the maximum width in a cross section of the core material is too large, volume of the reference electrode is large. Therefore, if the reference electrode is arranged between electrodes (a working pole and a counter pole), it will be difficult to keep constant the distance between the electrodes. Furthermore, when measuring an electrical resistance value, the reference electrode should ideally measure a potential in a certain point between both electrodes. However, if the maximum width in a cross section of the core material is too large, there will be both a distant place and a near place with respect to an electrode in the same reference electrode, and potential observed by positions in the reference electrode will be different.

From the above viewpoint, there is a proper range for the maximum width in a cross section of the core material used for the present invention. According to experiment by the present inventors, it turned out that a linear core material preferably has thin conductivity of a maximum width in a cross section of 5-50 micrometers (the range is not less than 5 micrometer but not more than 50 micrometers. The same goes for the followings). The maximum width in a cross section of a more desirable core material is 10-30 micrometers. Length or an aspect ratio of a core material is not specifically limited, but the length is preferably about 10-1000 mm and the aspect ratio is preferably about 1-500. One core material formed with its 2-20 single wires twisted is effective.

By the way, an electrolyte of an electrochemical cell in a non-aqueous system includes those made by dissolving a salt consisting of an anion of a compound containing halogen, such as ClO₄—, BF4-, PF6-, CF3SO3-, (CF3SO2) 2N-, (C2F5SO2)2N-, (CF3SO2)3C-, and (C2F5SO2)3C-, and a cation of alkaline metals, such as Li, K, and Na, in a high polar solvent available as an electrolytes of a rechargeable battery such as ethylene carbonate, propylene carbonate, dimethyl carbonate, diethyl carbonate, methylethyl carbonate, gamma-butyrolactone, N, N′-dimethylformamide, dimethyl sulfoxide, N-methylpyrrolidone, and m-cresol. Furthermore, it is possible to use a solvent and an electrolyte salt consisting of these basic solvents separately or in combination. Additionally, it may be preferable to use a gel-like electrolyte which is a polymer gel containing an electrolyte. Preferably, at least surface of the core material substantially has resistance to the above-mentioned electrolyte. The term “substantially have resistance” includes not only the case that the surface is not eroded at all, but also the case that normal function of the surface can be maintained during use, even if the surface is partially eroded. A conductive material (especially, metal) which does not substantially react to lithium or a lithium alloy and substantially has resistance to an electrolyte as mentioned above, has for example, a metal chosen from Ti (titanium), V (vanadium), Cr (chromium), Mn (manganese), Fe (iron), Co (cobalt), Ni (nickel), Cu (copper), Zn (zinc), Nb (niobium), Mo (molybdenum), Tc (technetium), Ru (ruthenium), Rh (rhodium), Ta (tantalum), W (tungsten), Os (osmium), Ir (iridium), Pt (platinum), and Au (gold), and an alloy, a stainless steel, or a stainless alloy consisting thereof. However, the conductive material may be glass or carbon etc. which has conductivity. A stainless steel or a stainless alloy includes a well-known high corrosive-resistant material such as a ferritic stainless steel (including a super ferritic stainless steel), an austenitic stainless steel (including a super austenitic stainless steel), a martensitic stainless steel, an austenitic-ferritic duplex stainless steel, a precipitation hardening stainless steel, a stainless alloy (alloys, such as a hastelloy, an Inconel, and Incoloy) etc. In particular, in terms of adhesion with lithium membrane, Ti, Cr, Ni, Cu, Pt, Au, a stainless steel, or a stainless alloy etc. is preferred, and furthermore, in terms of mechanical strength and material cost, a stainless steel or a stainless alloy is more preferred.

Even in the case that a metal suitable for alloying with lithium for a central part of the core material is used, the core material can be used without causing any problem if a surface of the core material is coated with the metal which is difficult to alloy with lithium as described above. For example, those having a steel wire etc. covered with nickel etc. correspond to this.

Although it is also possible to form a lithium membrane directly in the whole outer perimeter of the core material and to use it as a reference electrode, a region in the core materials which is not coated with the lithium membrane may be coated by with an insulator. When setting a reference electrode in an electrochemical cell, the reference electrode tends to contact with a working pole or a counter pole to create an electrical short. Then, a field to form a lithium membrane on the core materials is limited to a portion required for measuring potential, and the other fields are coated with the insulator in place of the lithium membrane in order to easily avoid an electrical short between the lithium membrane and a working pole or a counter pole. However, all of such fields may not be coated with the insulator and only a portion which may contact with an anode or a cathode may be coated with the insulator. Additionally, a voltage spike from the core material can also be reduced. Here, the insulator refers to those that have a function (pressure resistance) to endure potential difference to a certain degree between a conductor and a conductor, between a conductor and the ground. Therefore, if a current beyond a resisting pressure limit of the insulator flows, the insulator will be damaged, burned or the like. However, most insulators are actually usable since a current is not usually applied to a reference electrode. However, an electrolyte used for an electrochemical cell in a non-aqueous system is an organic solvent and an ionic liquid, and therefore the electrolyte is preferably an insulator with resistance to an organic solvent etc. For example, it preferably includes resin such as natural rubber (NB), ethylene propylene (EP), polyvinyl (PV), Polyethylene (PE), polypropylene (PP), polyacrylonitrile (PAN), polyimide (PI), cross-linked polyethylene (PEX), Hypalon, silicon rubber (silicone), and fluororesin etc., and Oxides such as zirconia, Chita Near, alumina, and silica, etc.

As mentioned above, the maximum width in a cross section of the core material is preferably in the range of 5-50 micrometers, and the core material is comparatively thin, regardless of any value within this range. However, if the lithium membrane is too thick, the maximum width in a cross section of the reference electrode may become large, which, as described above, disturbs a surrounding electric field of an electrode (a working pole or a counter pole) to be measured. Therefore, potential of the electrode cannot be measured correctly. On the other hand, if the lithium membrane is too thin, the core material will directly connect to an electrolyte and voltage of the core material will be mixed, which is a cause for noise. According to experiments by the current inventors, thickness of the lithium membrane is preferably in the range of not less than 0.1 micrometers but not more than 20 micrometers.

Since lithium etc. is a very active metal, it is easily oxidized with moisture in the air and with moisture contained in minute amounts in an electrolyte. Then, an outer surface of the lithium membrane is coated with a membrane of an ion-permeable substance which has waterproofness but substantially does not have electron conductivity, in order to avoid contact of the lithium membrane with water and to prevent a short circuit when electrodes and a reference electrode contact. The term “substantially does not have electron conductivity” means not only the case that there is no electron conductivity, but also the case that even if there is small amount of electron conductivity, it has little effect on measurement accuracy. The ion-permeable substance includes an ion-permeable polymer to permeate a lithium-ion and an oxide etc. which have waterproofness. Specifically, the substance includes Polyvinylidene fluoride (PVdF), polytetrafluoroethylene (PTFE), Polypropylene (PP), polyethylene (PE), polyimide (PI), polyamide imide (PAT), poly acrylics nitril (PAN), polyether imide (PEI), polyferrocenyldimethylsilane (PFDMS), aramid resin, glass, or the like.

A method of forming a lithium membrane on a core material includes, but is not specifically limited to, a crimping method, an aerosol deposition method, an electrolytic deposition method, and Physical Vapor Deposition etc. Each formation method is explained below.

The crimping method attaches the lithium membrane to a core material with anchor effect, by taking advantage of softness of the lithium etc. and by utilizing small asperity of the core material surface. This method is easiest and provides superior cost performance. However, this method does not provide high accuracy or uniformity of thickness of the lithium membrane.

The aerosol deposition method forms a thin membrane by injecting powder of lithium or the like present in positive pressure atmosphere to a core material present in negative pressure atmosphere at once. However, it is difficult to manufacture the powder such as powdered lithium and the powder requires careful handling since it is explosive.

The electrolytic deposition method electrochemically forms a lithium membrane on a core material. The lithium membrane can be formed only on an energized portion by using the electrolytic deposition method. However, accuracy of potential measurement using this method is not so high since a surface membrane is coated due to an electrolyte.

The physical vapor deposition includes, for example, vacuum deposition (resistance heating evaporation, electron beam evaporation, and laser ablation etc.), Sputtering (diode sputtering, magnetron sputtering, ECR sputtering, ion beam sputtering, and reactive sputtering etc.), Ion plating (a direct current or high frequency excitation ion plating, electron beam excitation ion plating, cluster ion plating, and reactive ion plating etc.). Of these sputtering, if the sputtering method is used, a high-density lithium membrane can be formed. However, compared with a vacuum evaporation method, the sputtering method requires ingenuity for forming a lithium membrane so as to cover the outer perimeter of the core material in a closed-circular pattern. Furthermore, the sputtering target has low utilization and poor cost performance. On the other hand, the vacuum evaporation method heats and evaporates the lithium materials from an evaporation source within a decompression chamber, and deposits the lithium etc. on a core material placed opposed to the evaporation source. This method allows to increase the rate of utilization of lithium materials by accordingly adjusting distance between the evaporation source and the core material, and also to form a lithium membrane in uniform thickness.

Therefore, the electrolytic deposition method and the vacuum evaporation method etc. are preferred as a method of forming a lithium membrane. By using such methods, the lithium membrane in uniform thickness can be easily formed on core material surface. Furthermore, by choosing suitable requirements, it is also possible to strengthen adhesion of the lithium membrane to the core material and to improve degree of smoothness of the lithium membrane surface. Additionally, by using such methods, a lithium membrane of a large area is obtained easily and inexpensively, and thus can be mass-produced.

An electrochemical cell of the present invention comprises at least one reference electrode as described above, and a working pole and a counter pole which are placed to face each other across the reference electrode. The electrochemical cell has a working pole (anode) and a counter pole (cathode), causes battery change between these electrodes by an electrochemical reaction, and functions as a major portion such as for instance a lithium-ion battery (a lithium primary battery and a lithium rechargeable battery) and a capacitor etc. If the reference electrode of the present invention mentioned above is used as a part of an electrochemical cell, it is possible to accurately measure potential and resistance of an electrode in the electrochemical cell, or resistances of an electrolyte between the electrodes and of a separator, by utilizing a reference electrode suitable for utilization and mass production.

In particular, if so called a four-electrode configuration comprising a working pole reference electrode and a counter pole reference electrode as a reference electrode is provided, it is possible to accurately control charge and discharge based on each potential difference between the working pole-the working pole reference electrode, the working pole-the counter pole reference electrode, the counter pole-the working pole reference electrode, and the counter pole-the counter pole reference electrode, by using the reference electrode suitable for utilization and mass production. Thus, if each reference electrode is placed adjacent to the working pole and the counter pole, each reference electrode will not be subject to an electrode placed farther, respectively. However, if the reference electrode comes very close to the electrode, it disturbs an electric field adjacent to the corresponding electrode, making it difficult to measure accurate potential. Then, it is preferred to maintain about 100-500 micrometer distance. On the other hand, it is also preferred to maintain the distance between the working pole reference electrode and the counter pole reference electrode at about 100-1000 micrometers for the same reason described above. Furthermore, the electric field will be disturbed if this distance is too small. On the other hand, if the distance is too large, an electrochemical cell with a high internal resistance is provided to be unsuitable for evaluation or practical use, because an electrolyte used for a lithium-ion battery (a lithium primary battery and a lithium rechargeable battery) and a capacitor etc. typically has high resistance. Therefore, the distance between the working pole electrode and the counter pole electrode is preferably in the range of 1-2 mm.

### Effect of the Invention

According to the present invention, improvement of the configuration of the above-mentioned reference electrode can provide a reference electrode easy to handle and manufacture, its manufacturing method, and an electrochemical cell using this can be provided by improvement of the above structures of the reference electrode.

### BRIEF DESCRIPTION OF FIGURES

FIG. 1 is a perspective view schematically showing a structure of an electrochemical cell with regard to an embodiment.

FIGS. 2(a) and 2(b) are, in turn, a perspective view and a cross sectional view of a reference electrode.

FIG. 3 is an optical micrograph figure of a reference electrode according to an embodiment.

FIG. 4 is a cross sectional view showing a modification, of a reference electrode.

FIGS. 5(a)-5(d) are cross sectional views showing manufacturing processes of a reference electrode according to a modification.

FIG. 6 shows a discharge-and-charge curve obtained by a discharge-and-charge cycle experiment about the sample of Example 1.

FIG. 7 is an enlarged view of the charge-and-discharge curve in the vicinity of a rest point B1 in the FIG. 6.

FIG. 8 shows a discharge-and-charge curve obtained by a discharge-and-charge cycle experiment about the sample of Example 2.

FIG. 9 shows a discharge-and-charge curve obtained by a discharge-and-charge cycle experiment about the sample of Example 3.

FIG. 10 shows a charge-and-discharge curve obtained by the charge-and-discharge cycle experiment about the sample of a comparative example 1.

FIG. 11 shows in a tabular form sample structures in each embodiments and comparative examples, and an average of difference between potential difference (V+R+) and potential difference (V+R−) during current break for 60 seconds.

### DETAILED DESCRIPTION OF THE INVENTION

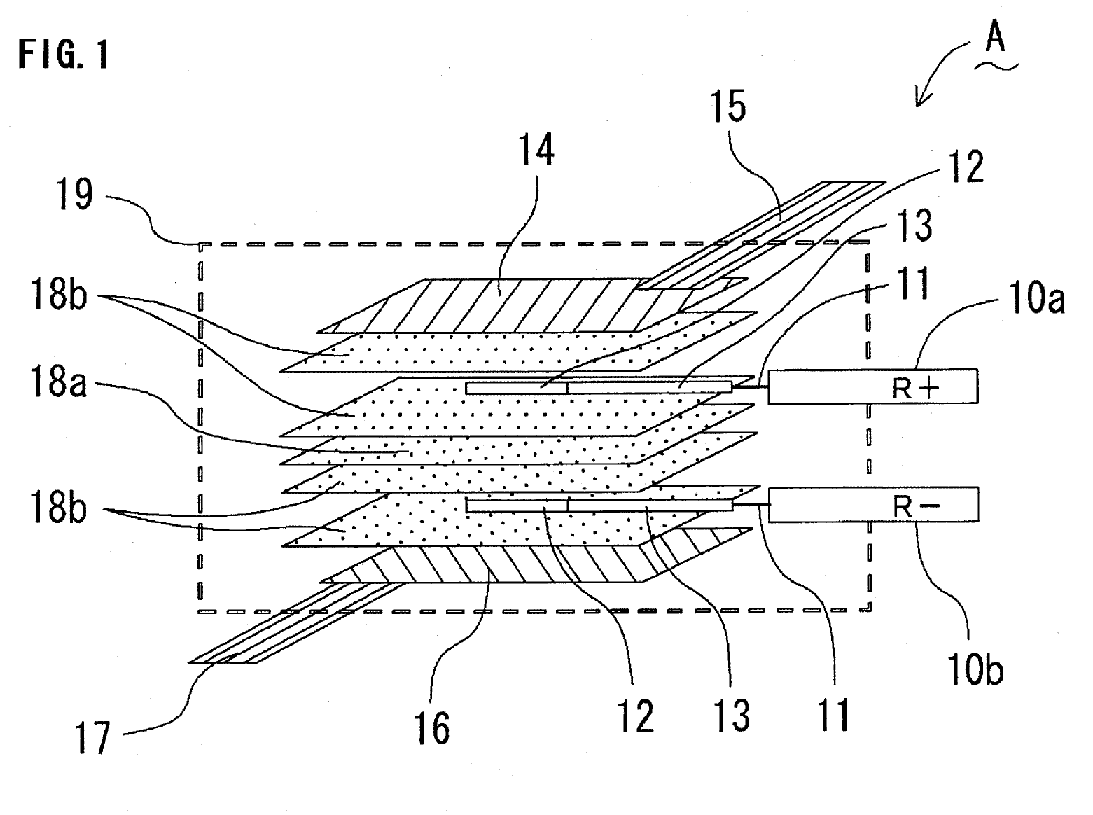

FIG. 1 is a perspective view schematically showing a structure of an electrochemical cell A with regard to an embodiment of the present invention. This electrochemical cell A is used as a major part of a lithium rechargeable battery, however, the electrochemical cell of the present invention is not necessarily limited to those used as parts of lithium rechargeable batteries. The electrochemical cell A in the present embodiment has a so called square-type laminated cell structure with an anode 14 (a working pole) and a cathode 16 (a counter pole) which are placed to face each other across a separator 18a in a battery container 19. Although not shown diagrammatically, the battery container 19 consisting of aluminum laminate is filled with the electrolyte.

Furthermore, in the battery container 19, an anode reference electrode 10a (a working pole reference electrode) is arranged adjacent to an anode 14 in the field between the anode 14 and the cathode 16, and a cathode reference electrode 10b (a counter pole reference electrode) is arranged adjacent to the cathode 16 in the field between the anode 14 and the cathode 16. The anode 14 and the anode reference electrode 10a are arranged parallel to each other via a separator 18b. Similarly, the cathode 16 and the cathode reference electrode 10b are arranged parallel to each other via a separator 18b. Additionally, the separator 18b is also arranged between the anode reference electrode 10a and the separator 18a, and between the cathode reference electrode 10b and the separator 18a, respectively. That is, the electrochemical cell A according to the present embodiment comprises a so-called four-electrode cell structure with the anode reference electrode 10a and the cathode reference electrode 10b arranged in the field between the anode 14 and the cathode 16. However, the electrochemical cell of the present invention is not limited to those that have the above-mentioned four-electrode cell structure, and may have a three-electrode cell structure with a single reference electrode arranged in the field between an anode and a cathode.

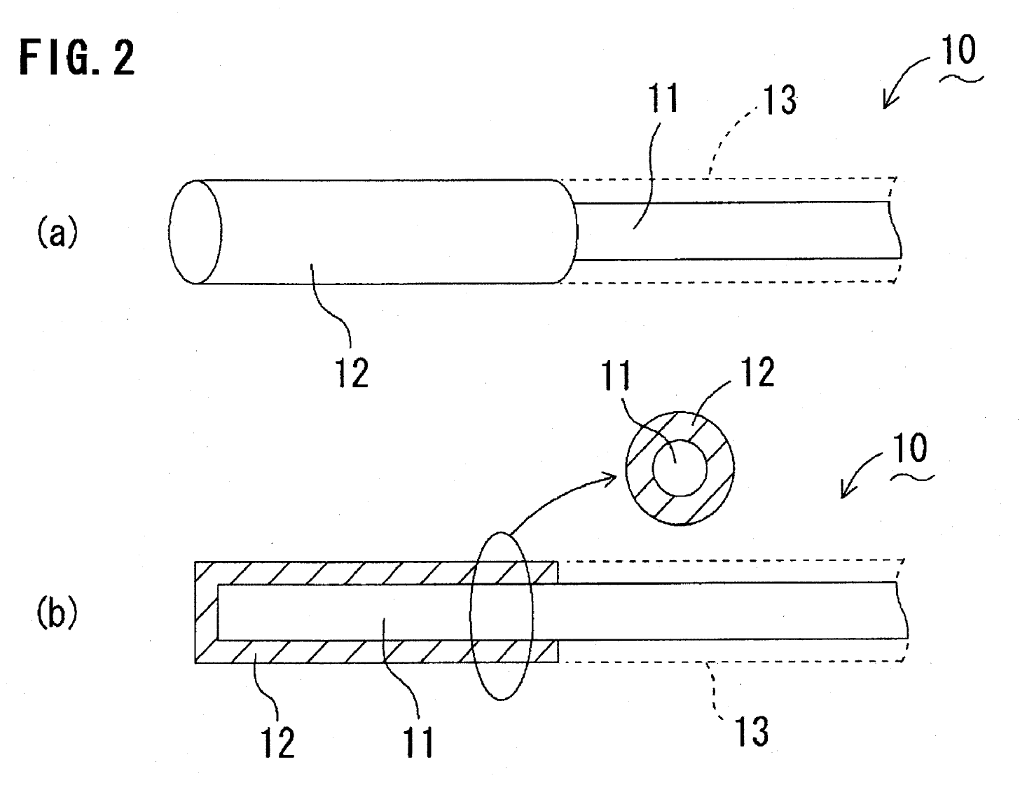

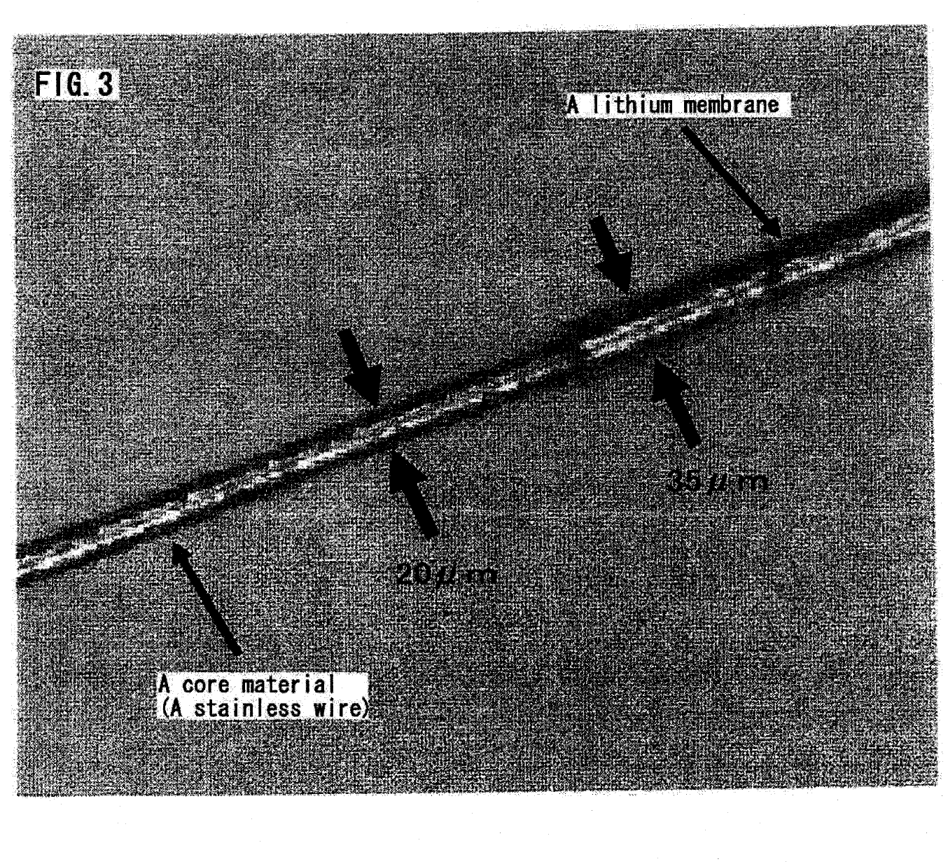

FIGS. 2(a) and 2(b) are, in turn, a perspective view and a cross sectional view of a reference electrode 10 (referring to an anode reference electrode 10a and a cathode reference electrode 10b. The same goes for the followings). FIG. 3 is an optical micrograph figure of a reference electrode 10 according to an embodiment. As shown in FIGS. 2(a) and 2(b), the reference electrode 10 according to the present embodiment comprises a core material 11 extending parallel to the anode 14 or the cathode 16 from a terminal, a lithium membrane 12 consisting of lithium (a so-called metallic lithium) and coating from a tip of the core material 11 to a field with predetermined length, and an insulator 13 partially coating a field uncoated with the lithium membrane 12 in the core material 11. The lithium membrane 12 may be formed in the field required for measurement of potential, and, the other part may be preferably coated with the insulator 13. The insulator 13 may be formed in the field where the insulator 13 possibly contacts with the anode 14 or the cathode 16. Furthermore, the insulator 13 is not necessarily provided. As shown in FIG. 3, in this embodiment, a stainless steel wire (a stainless steel or a stainless alloy) with a diameter of 20 micrometers is used as the core material 11, and thickness of the lithium membrane 12 is 7.5 micrometers.

In this embodiment, the core material 11 wholly comprises a stainless steel or a stainless alloy (stainless steel wire), which are conductive materials that do not substantially react to lithium or lithium alloy. Only the surface of the core material 11 may comprise the conductive materials that do not substantially react to lithium or lithium alloy. Further in this embodiment, as an electrolyte of electrochemical cell A, the electrolyte is applied, wherein the electrolyte is selected from those made by dissolving a salt consisting of an anion of a compound containing halogen, such as ClO4-, BF4-, PF6-, CF3SO3-, (CF3SO2)2N-, (C2F5SO2)2N-, (CF3SO2)3C-, and (C2F5SO2)3C and an cation of alkaline metals such as Li, K, Na, in a high polar solvent available as an electrolytes of the rechargeable battery. For the high polar solvent, ethylene carbonate, propylene carbonate, dimethyl carbonate, diethyl carbonate, methylethyl carbonate, gamma-butyrolactone, N, N′-dimethylformamide, dimethyl sulfoxide, N-methylpyrrolidone, m-cresol, etc. are employed. According to the embodiment, the material which substantially has resistance to the electrolyte is at least applied to at least the surface of the core material 11. The conductive materials (especially metal) which do not substantially react to lithium or a lithium alloy, and substantially have resistance to the electrolyte mentioned above are metals, alloys, stainless steels, or stainless alloys selected from Ti (titanium), V (vanadium), Cr (chromium), Mn (manganese), Fe (iron), Co (cobalt), Nickel (nickel), Cu (copper), Zn (zinc), Nb (niobium), Mo (molybdenum), Tc (technetium), Ru (ruthenium), Rh (rhodium), Ta (tantalum), W (tungsten), Os (osmium), Ir (iridium), Pt (platinum), and Au (Gold). According to the present embodiment, a stainless steel or a stainless alloy is used as a material for core material 11, from the view points of material cost and adhesiveness to lithium membrane 12. However, a steel cable plated with Ni etc. may be employed as the core material 11, because at least the surface of the core material 11 is formed in the conductive materials that do not substantially react to lithium or lithium alloy.

The anode 14 is formed in a plate whose plane shape is a rectangle, and the plane size is 1.4 cm×2.0 cm, for example. For example, aluminum foil about 18 micrometer thickness is used as current-collecting object, and anode 14 is formed by applying 80-micrometer-thick anode layer on one side of the current-collecting object (plane opposed to cathode 16), wherein the anode layer includes iron phosphate lithium (LiFePO4) as a active material. For example, composition of the anode layer is LiFePO4:85 wt % KB:5 wt % PVdF:10 wt %. The shape of the cathode 16 is almost the same as the anode 14. A copper foil about 20 micrometer thickness is used as a current-collecting object, and the cathode 16 is formed by applying 30-micrometer-thick cathode layer on one side of the current-collecting object (plane opposed to cathode 16), wherein the cathode layer includes SiO as a active material. For example, the composition of the cathode layer is SiO:80 wt %, KB:5 wt %, PI:15 wt %. However, the structures, such as shapes or active materials of those of the anode 14 and the cathode 16, are not limited to the embodiment.

In this embodiment, the distance between the anode 14 and the anode reference electrode 10a is for example 400 micrometers. They are arranged so that lithium membrane 12 of the anode reference electrode 10a may oppose to the central part of anode 14, and so that the anode 14 and anode reference electrode 10a may be placed parallel each other. Similarly, the distance between the cathode 16 and the cathode reference electrode 10b is, for example, 400 micrometers. They are arranged so that the lithium membrane 12 of the cathode reference electrode 10b may oppose to the central part of cathode 16, and so that the cathode 16 and cathode reference electrode 10b may be placed parallel each other. The distance between the anode reference electrode 10a and the cathode reference electrode 10b is 1000 micrometers, and the distance between the electrodes of the anode 14 and the cathode 16 is 600 micrometers. As mentioned above, the distance between the anode reference electrode 10a and cathode reference electrode 10b may be in the range of 100-1000 micrometers, and the distance between the electrodes of the anode 14 and cathode 16 may be in the range of 1-2 mm.

Also, the separators 18a and 18b may be both monotonous glass filters in the thickness of 200 micrometer, and the plane shape is a elongate and slender rectangle.

As in this embodiment, the anode reference electrode 10a is arranged near the anode 14, so that the anode reference electrode 10a is insusceptible to the electric field in the cathode 16. However, when the anode reference electrode 10a is set too close to the anode 14, the electric field will be disturbed near the anode 14, which makes it difficult to measure the exact potential. Therefore, it is preferable to set the distance between the anode 14 and the anode reference electrode 10a around 100-500 micrometers. Similarly, it is preferable to set the distance between the distance of the cathode 16 and the cathode reference electrode 10b around 100-500 micrometers.

According to this embodiment, the following effects may be achieved. In this embodiment, the reference electrode 10 does not wholly comprise lithium or lithium alloy, but comprises the core material 11 consisting of a stainless steel wire, and the lithium membrane 12 formed on the core material 11. Thus, using the core material 11 consisting of a higher rigid material than the lithium membrane 12 makes it easy to handle and manufacture, as mentioned above. Further, when employing the four-electrode cell structure in which the anode reference electrode 10a and the cathode reference electrode 10b are arranged, charge and discharge may be well controllable based on potential differences between the anode-anode reference electrodes, between the anode-cathode reference electrodes, between the cathode-anode reference electrodes, and between the cathode-cathode reference electrodes respectively by using the reference electrode suitable for practical use and mass-production.

Employing the high rigid core materials 11 such as stainless wire, it is possible to form the reference electrode 10 in a thin wire with a diameter of 35 micrometers (refer to FIG. 3). Thus, employing the reference electrode 10 in a thin wire, it is possible to arrange the anode 14, the cathode 16, the anode reference electrode 10a, and the cathode reference electrode 10b in the above-position. As a result, comparing with the conventional 3-electrode lithium rechargeable batteries or 4-electrode lithium rechargeable batteries, the potential differences between the anode-anode reference electrodes are useful for correctly grasping the present potential and the potential change in the cathode 16 alone at the time of charge and electric discharge.

Similarly, compared with the conventional 3-electrode lithium rechargeable batteries or 4-electrode lithium rechargeable batteries, the potential differences between the cathode-cathode reference electrodes are useful for correctly grasping the present potential and the potential change in the cathode 16 alone at the time of charge and electric discharge.

As mentioned above, it is possible to position the anode 14 (and the cathode 16) and the anode reference electrode 10a (and the cathode reference electrode) in parallel via the separator 18b, and to position the anode reference electrode 10a (and the cathode reference electrode 10b) in any places on the anode 14 (and the cathode 16). And since the reference electrode 10 is very thin, it is possible to measure a potential in any positions in the anode 14 (and the cathode 16), and it is also possible to use it for measuring the potential distribution in the anode 14 (and the cathode 16).

### —Modification of the Reference Electrode—

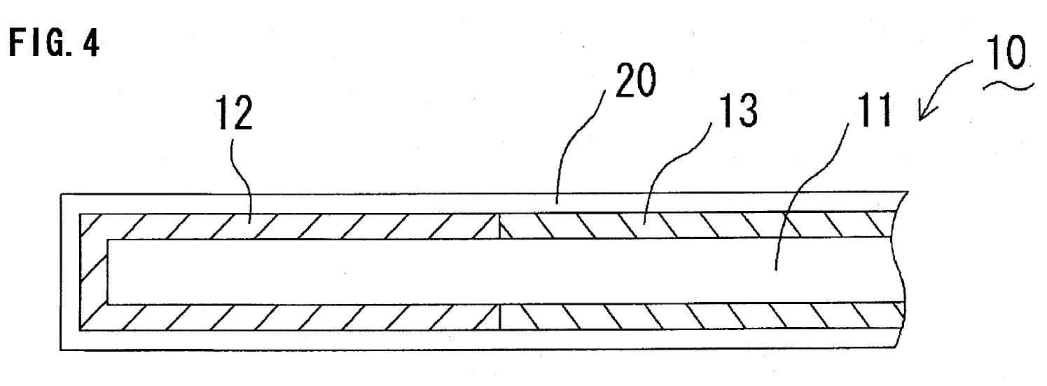

FIG. 4 is a sectional view showing a modification of the reference electrode 10. As shown in the figure, the reference electrode 10 according to this modification example is provided with ion permeable protection film 20 (ion permeable substance film) which coats the lithium membrane 12 and the insulator 13. The insulator 13 does not need to be coated with the ion permeable protection film 20. The ion permeable protection film 20 according to this modification example is formed in the polyvinylidene fluoride (PVdF) which has permeability against lithium ion and waterproof, and has no electron conductivity. Since lithium etc. are very active metals, they are easily oxidized by the moisture contained in air or in an electrolyte in the very small amount. Then, as indicated in the modification example, the outer surface of the lithium membrane 12 is coated with ion permeable protection membrane 20 that has waterproof but not substantially have electron conductivity, which enables the lithium membrane 12 to avoid contacting with the electrolyte, and prevent electric short when the anode 14 is contacted with the anode reference electrode, or the cathode 16 is contacted with the cathode reference electrode 10b.

### —Manufacturing Process of the Reference Electrode—

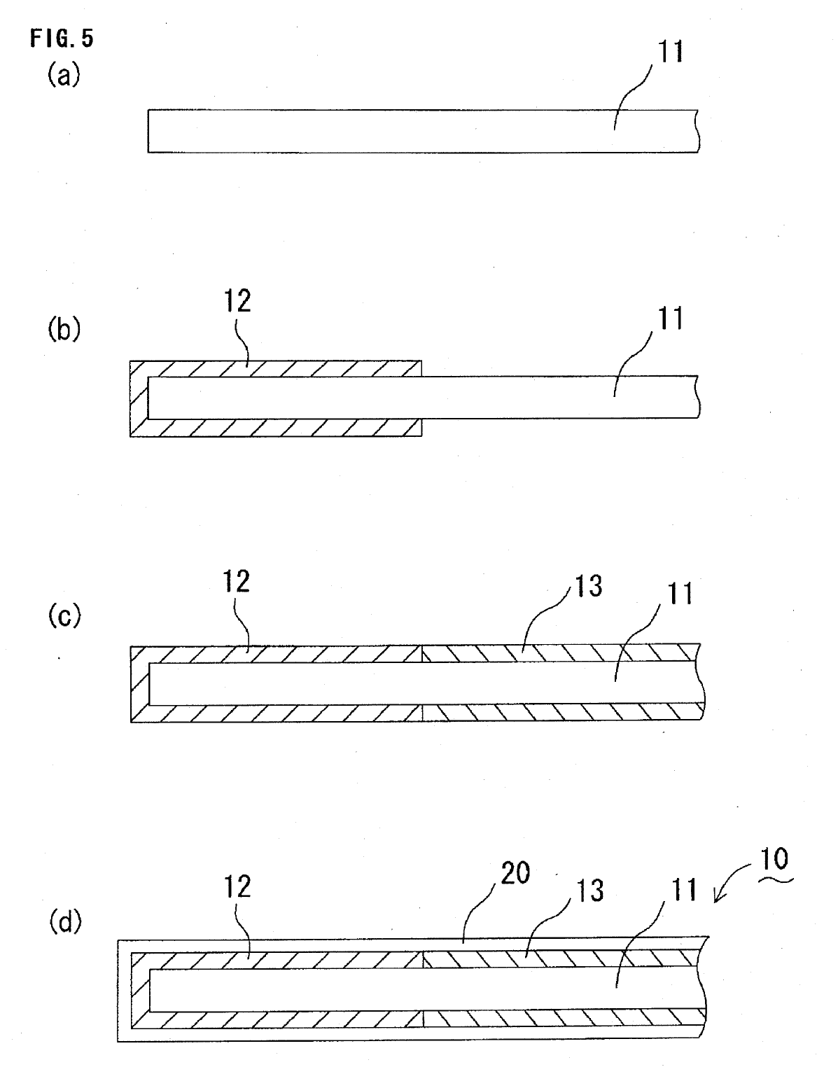

Next, the method for manufacturing the reference electrode 10 is explained, referring to the case of the structure in the above-mentioned modification. FIG. 5 (a)-(d) are cross-sectional views showing the manufacturing processes of the reference electrode 10 concerning the above-mentioned modification examples. First, the core material 11 consisting of a stainless steel wire in a desired length is formed in the process shown in FIG. 5 (a). Next, the lithium membrane 12 is formed by depositing lithium on a predetermined place on the core material 11 using a vacuum evaporation method in the process shown in FIG. 5 (b). Depending on the lithium material temperature to be heated, the distance from an evaporation source to the core material 11 is set in the range of 5-30 cm, preferably in the range of 10-20 cm, and it is preferable to set the distance under the reduced pressure of 0.05-0.5 Pa, more preferably of 0.05-0.5 Pa. Depending on the condition for the reduced pressure, the heating temperature for the lithium materials is set in the range of 400-600 degrees C., preferably in the range of 450-550 degrees C. Since the rate for evaporating lithium materials is slow under 400 degrees C., the lithium membrane 12 is formed uniformly, but has poor productivity. The rate for evaporating lithium materials is fast beyond 600 degrees C., however the lithium membrane 12 has poor uniformity. In this example, the lithium membrane 12 is formed in a vacuum evaporation method, but an electrolytic deposition method is used instead. In such a case, depending on the solvent contained in the electrolytic deposition bath, the lithium salt may be set in the range of 0.01-5 mol/L, preferably in the range of 0.1-1 mol/L, and the current density may be set in the range of 0.1 mA/cm2-100 mA/cm2, preferably in the range of 1 mA/cm2-10 mA/cm2.

Next, in the process shown in FIG. 5 (c), the insulator 13 is coated on a region of the core material 11 where the lithium membrane 12 is not yet formed in a core material 11 in the process shown in FIG. 5 (c). In this example, the insulating material is used as the insulator 13, wherein the material is selected from the insulators having a resistance to organic solvent etc. such as Natural rubber (NB), Ethylene propylene (EP), Polyvinyl (PV), Polyethylene (PE), Polypropylene (PP), Polyacrylonitrile (PAN), Polyimide (PI), Cross-linked polyethylene (PEX), Hyperlon, and Silicon rubber (silicone); from the insulating resin such as fluororesin; and from the oxides such as zirconia, Chita Near, alumina, and silica. In this example, the insulator 13 is formed around the core material 11 by immersing in the melt of the insulating resin the area where the lithium membrane 12 is not formed on the core material. However, it is not limited to this example.

Next, the ion permeable protection film 20 is formed on the surface of the surface of the lithium membrane 12 and the insulator 13 in the process shown in FIG. 5 (d). The coating method etc. are used for the method for forming the ion permeable protection film 20. For example, the ion permeable protection film 20 may be formed on the surface of the lithium membrane by dipping the reference electrode 10 to the coat liquid in which the ion permeability polymer dissolved in the organic solvent, and then by volatilizing the organic solvent. Alternatively, the ion permeable protection film 20 consisting of ion permeable resins or oxide may be also formed by spraying the coat liquid or powder thereof in a spray gun. It is preferable to set the thickness of the ion permeable protection film 20 in a range of 1-20 micrometers, more preferably in a range of 2-10 micrometers. The film has poor water resistance, when the thickness is less than 1 micrometer. On the other hand, the above problems may happen in the thickness beyond 20 micrometers, since the film has a larger maximum width in the section of the reference electrode 10. It becomes difficult to form the ion permeable protection film 20 in a uniform thickness.

### Example

### Creation of a Sample

Next, for example, the samples for characteristic evaluation on the reference electrode 10 and the electrochemical cell A (the lithium rechargeable battery), i.e., the samples for each examples having the structure of the present invention and the samples for each of the comparative examples for comparing the performances with the examples are prepared.

### Example 1

In a vacuum evaporation method, the anode reference electrode 10a and the cathode reference electrode 10b are both prepared on the surface of the core material 11 consisting of a stainless steel wire with a diameter of 20 micrometers to form a lithium membrane 12 with a thickness of 7 micrometers. The anode reference electrode 10a and the cathode reference electrode 10b were set to the position opposed to the central part of the anode 14 and the cathode 16, respectively. The reference electrode 10 is formed based on the vacuum evaporation method under the following condition; isolating the core material 11 from the evaporation source by 10 cm, heating the lithium materials to 480 degrees C. under the reduced pressure of 1.0×10 to 3 Pa., evaporating the lithium materials and forming the lithium membrane 12 coating the outer periphery of the core material 11 in a closed circular.

### Example 2

And in a vacuum evaporation method, a lithium membrane 12 with a thickness of 10 micrometer is formed on the surface of the core material 11 by using a stainless steel wire with a diameter of 40 micrometer as the core material 11 of the reference electrode 10. Other conditions are the same as Example 1.

### Example 3

And in a vacuum evaporation method, a lithium membrane 12 with a thickness of 5 micrometer is formed on the surface of the core material 11 by using a stainless steel wire with a diameter of 10 micrometer as the core material 11 of the reference electrode 10. Other conditions are the same as Example 1.

### Example 4

And in a vacuum evaporation method, a lithium membrane 12 with a thickness of 1 micrometer is formed on the surface of the core material 11 by using a stainless steel wire with a diameter of 10 micrometer as the core material 11 of the reference electrode 10. Other conditions are the same as Example 1.

### Example 5

And in a vacuum evaporation method, a lithium membrane 12 with a thickness of 15 micrometer is formed on the surface of the core material 11 by using a stainless steel wire with a diameter of 20 micrometer as the core material 11 of the reference electrode 10. Other conditions are the same as Example 1.

### Example 6

As the reference electrode 10, the ion permeable protection film 20 consisting of the polyvinylidene fluoride PVdF is formed to have the thickness of 5 micrometer on the lithium membrane 12 formed under the condition in example 1. Other conditions are the same as Example 1.

### Example 7

As reference electrode 10, the ion permeable protection film 20 consisting of polyvinylidene fluoride PVdF is formed to have the thickness of 30 micrometer on a lithium membrane 12 formed under the condition in example 1. Other conditions are the same as Example 1.

Furthermore, each of the comparative examples was created as samples for comparing with the examples.

### Comparative Example 1

Lithium foil with a thickness of 500 micrometer is cut in a width of 2 mm, and is used as the reference electrode 10. Other conditions are the same as Example 1.

### Comparative Example 2

And in a vacuum evaporation method, a lithium membrane 12 with a thickness of 7 micrometer is formed on the surface of the core material 11, by using the stainless steel wire with a diameter of 70 micrometer as the core material 11 of the reference electrode 10. Other conditions are the same as Example 1.

### Comparative Example 3

And in a vacuum evaporation method, a lithium membrane 12 with a thickness of 50 micrometer is formed on the surface of the core material 11 by using the stainless steel wire with a diameter of 20 micrometer as the core material 11 of the reference electrode 10. Other conditions are the same as Example 1.

### Evaluation on Internal Resistance

The current-rest method is preferably used in order to measure the inner electrical resistance of the direct current. Here, by a charge and discharge cycle test, the inner electrical resistance of the direct current was measured for an electrochemical cell A that employs each of the example and the competitive examples as the reference electrode. Hereafter, the method and result are explained.

### —Evaluation on Example 1—

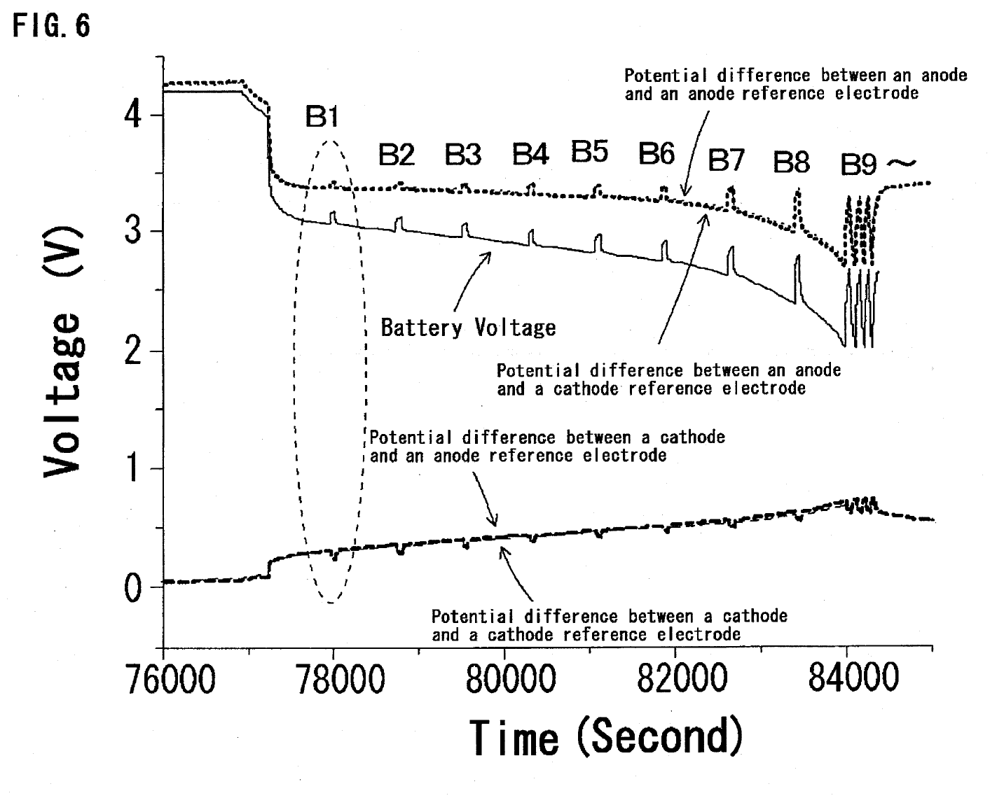

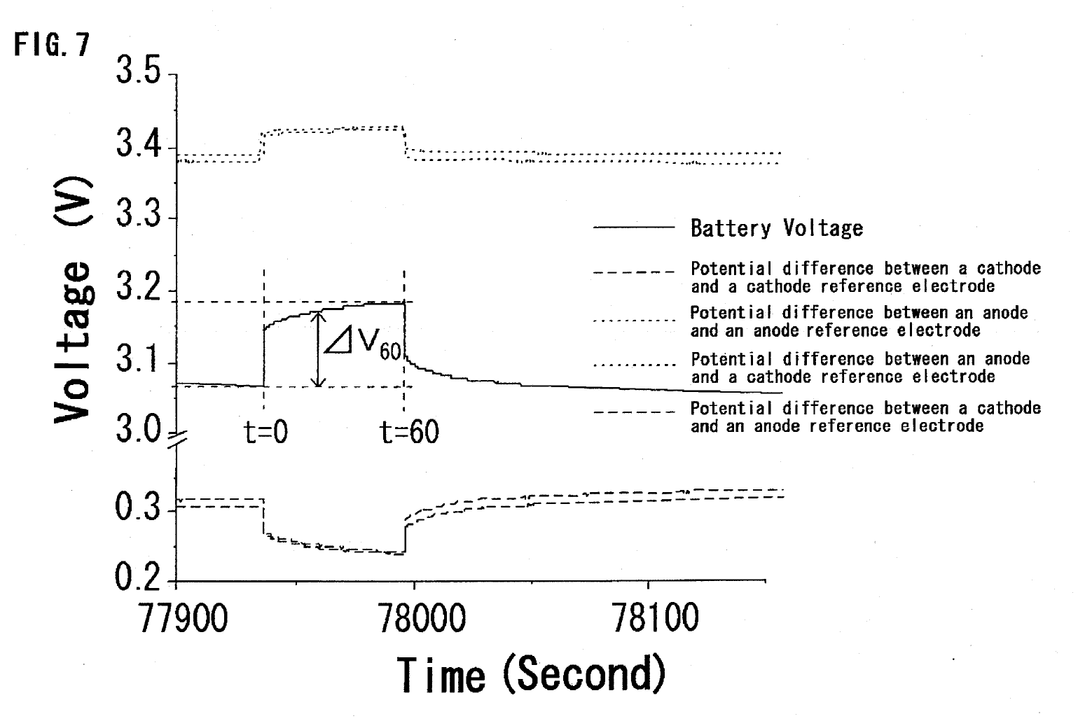

After discharging a full-charged electrochemical cell A for 12 minutes in a discharge rate of 0.5C, rest state (state where current is not passed) was held for 1 minute, and the above operation was repeated for 10 cycles until the voltage of electrochemical cell A is reaches to 2.0V. FIG. 6 shows a charge and discharge curve (time change characteristic of voltage) including a current rest point in this case. FIG. 7 is an enlarged view of the charge and discharge curve near the rest point B1 indicated in FIG. 6. Some voltage axes are omitted in FIG. 7. As shown in FIG. 7, five kinds of charge and discharge curves are obtained. Battery voltage (voltage between anode-cathode) (V+V−), and Potential difference ΔV between each electrodes and each reference electrodes are shown in the charge and discharge curves displayed herein. The Potential difference ΔV between each electrodes and each reference electrodes includes the potential differences between the anode-anode reference electrode (V+R+), between the anode-cathode reference electrode (V+R−), between the cathode-anode reference electrode (V−R+), and between the cathode-cathode reference electrode (V−R−).

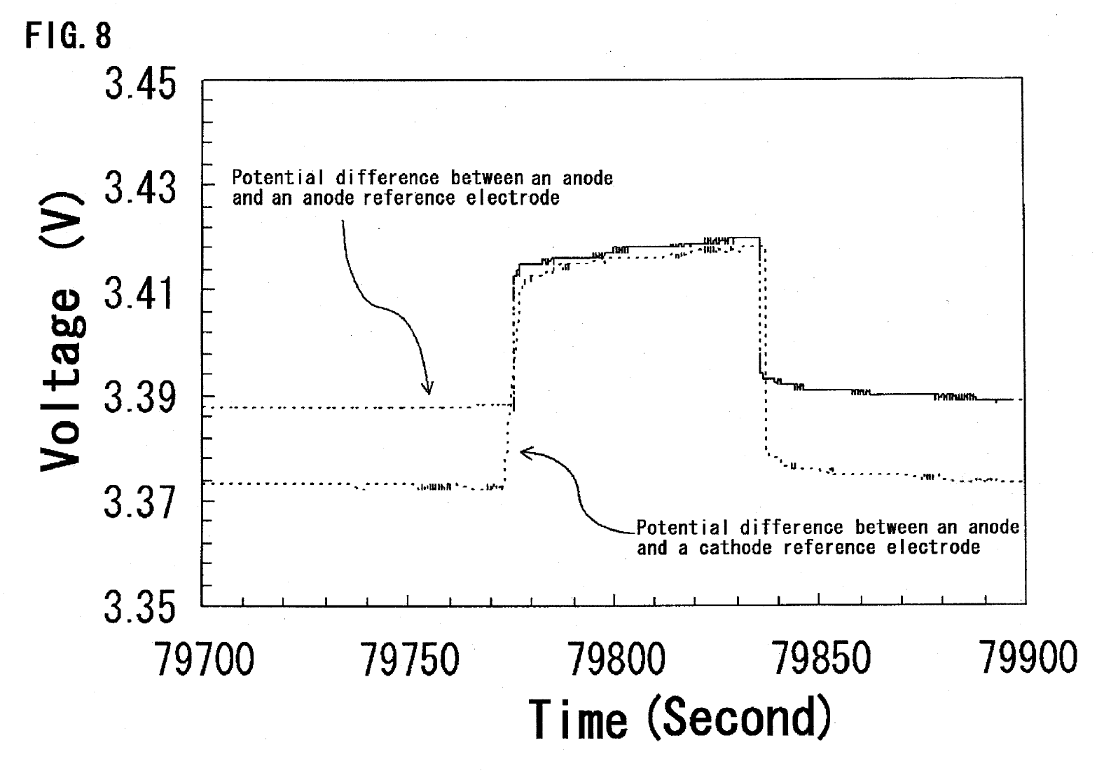

The potential in the anode 14 is measured from the above-mentioned potential difference (V+R+) and potential difference (V+R−), and the potential in the cathode 16 is measured from the potential difference (V−R−) and potential difference (V−R+). At this time, the differential between the potential difference (V+R+) and the potential difference (V+R−) during applying current has the same value as the differential between the potential difference (V−R+) and the potential difference (V−R−)(In order to avoid the complication, they are only described as the potential difference (V+R+) and the potential difference (V+R−) in the following FIGS. 8, 9 and 10). Since these differentials correspond to IR drops made from the resistance R in the separator and the electrolyte which exist between the anode reference electrode 14 and the cathode reference electrode 16, it is possible to obtain information the resistance R of the electrolyte and the separator.

The potentials in the anode 14 and the cathode 16 are measured based on the potential difference (V+R+) and the potential difference (V−R−) from which the influence of the resistance of the electrolyte and the separator is removed. Therefore, when changing a current value (changing from current value equivalent to 0.5 C discharging rate to current value zero in this evaluation), each of the values of the resistance components is obtained from the measured potential difference (ΔV) and the current value. In this evaluation, each resistances was calculated from the potential difference (ΔV60) after 60 seconds from resting the current, and just before a current rest (t=0). 69.6 Ohm was calculated for the whole battery resistance obtained in the evaluation above at the discharging rest point B1. Of the total, 9.2 Ohm was calculated for the anode resistance component, 20.9 Ohm for the cathode resistance component, and 39.5 Ohm for the resistance component of the electrolyte and the separator.

At the time of the 60 second-current rest in FIG. 7, the average potential difference between the potential differences (V+R+) and (V+R−) is 1.0 mV, which indicates that the difference are almost lost. This is because there is no IR drops from the resistance R of the separator and the electrolyte which exist between the anode reference electrode and the cathode reference electrode, when the current does not flow. Employing the reference electrode 10 and the electrochemical cell A in the present invention, the exact measurement may be achieved.

### —Evaluation on Example 2—

Also with regard to the sample of the example 2, the inner resistance of the direct current is evaluated based on the same charge and discharge cycle experiment as in the example 1. FIG. 8 shows the time change characteristic (charge and discharge curve) between the following potential differences; the obtained potential difference between the anode-anode reference electrode (V+R+) in the discharging rest point B1, and the potential difference between the anode-cathode reference electrode (V+R−). In the charge and discharge curve in the figure, the convex portion above shows the potential at the time of the 60 second-current rest. The average differential between the potential differences (V+R+) and (V+R−) at the time 1.3 mV, which correctly indicates the anode potential.

### —Evaluation on Example 3—

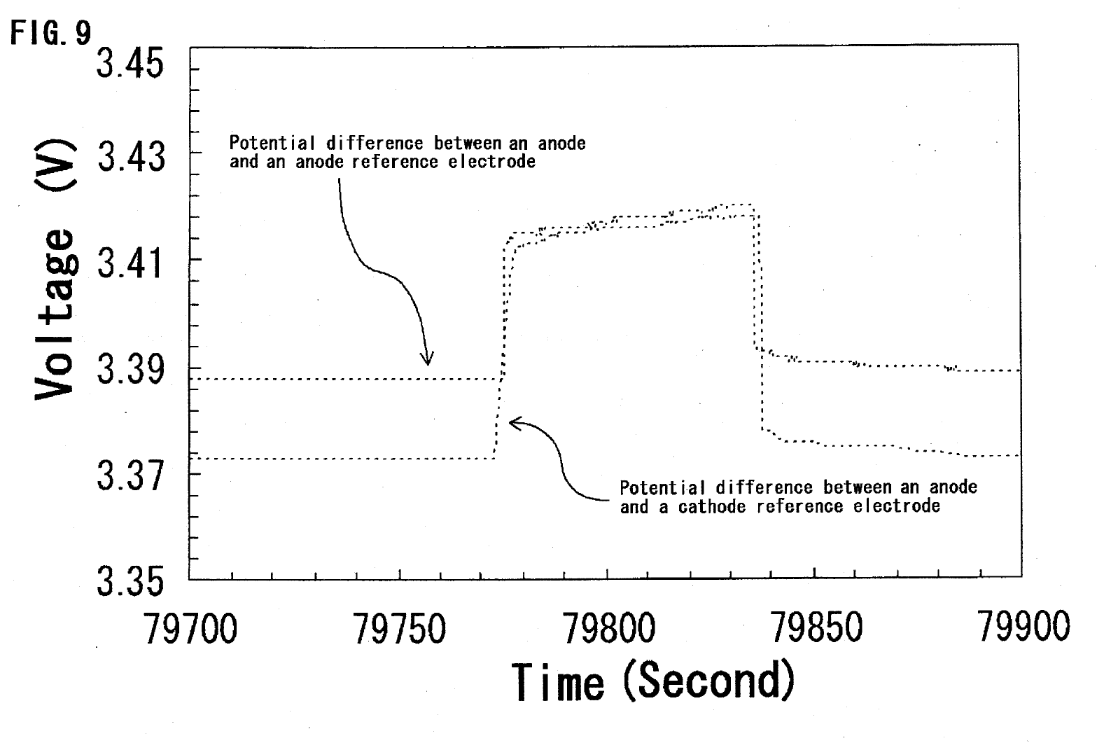

Also with regard to the sample of the example 3, the inner resistance of the direct current is evaluated based on the same charge and discharge cycle experiment as in the example 1. FIG. 9 shows the time change characteristic (charge and discharge curve) between the following potential differences; the obtained potential difference between the anode-anode reference electrode (V+R+) in the discharging rest point B1, and the potential difference between the anode-cathode reference electrode (V+R−). In the charge and discharge curve in the figure, the convex portion above shows the potential at the time of the 60 second-current rest. The average differential between the potential differences (V+R+) and (V+R—) at the time is 1.2 mV, which correctly indicates the anode potential.

### —Evaluation on Example 4—

Also with regard to the sample of the example 4, the inner resistance of the direct current is evaluated based on the same charge and discharge cycle experiment as in the example 1. The illustration of the obtained discharge curve is omitted. After measuring the potential difference between the anode-anode reference (V+R+) and the potential difference between anode-cathode reference (V+R—) in the discharging rest B1, the average differential between the potential differences (V+R+) (V+R−) at the time of the 60 second-current rest is 1.8 mV, which correctly indicates the anode potential.

### —Evaluation on Example 5—

Also with regard to the sample of the example 5, the inner resistance of the direct current is evaluated based on the same charge and discharge cycle experiment as in the example 1. The illustration of the obtained discharge curve is omitted. After measuring the potential difference between the anode-anode reference (V+R+) and the potential difference between anode-cathode reference (V+R—) in the discharging rest B1, the average differential between the potential differences (V+R+) (V+R—) at the time of the 60 second-current rest is 1.7 mV, which correctly indicates the anode potential.

### —Evaluation on Example 6—

Also with regard to the sample of the example 6, the inner resistance of the direct current is evaluated based on the same charge and discharge cycle experiment as in the example 1. The illustration of the obtained discharge curve is omitted. After measuring the potential difference between the anode-anode reference (V+R+) and the potential difference between anode-cathode reference (V+R—) in the discharging rest B1, the average differential between the potential differences (V+R+) (V+R—) at the time of the 60 second-current rest is 1.7 mV, which correctly indicates the anode potential.

### —Evaluation on Example 7—

Also with regard to the sample of the example 6, the inner resistance of the direct current is evaluated based on the same charge and discharge cycle experiment as in the example 1. The illustration of the obtained discharge curve is omitted. After measuring the potential difference between the anode-anode reference (V+R+) and the potential difference between anode-cathode reference (V+R—) in the discharging rest B1, the average differential between the potential differences (V+R+) (V+R−) at the time of the 60 second-current rest is 3.2 mV. Although the evaluation accuracy of the anode potential is comparatively high, the accuracy is slightly inferior to that of the example 6, because it is considered that the ion permeable protection film 20 has the thickness more than 30 micrometer in the sample of the example 7.

### —Evaluation on Comparative Example 1—

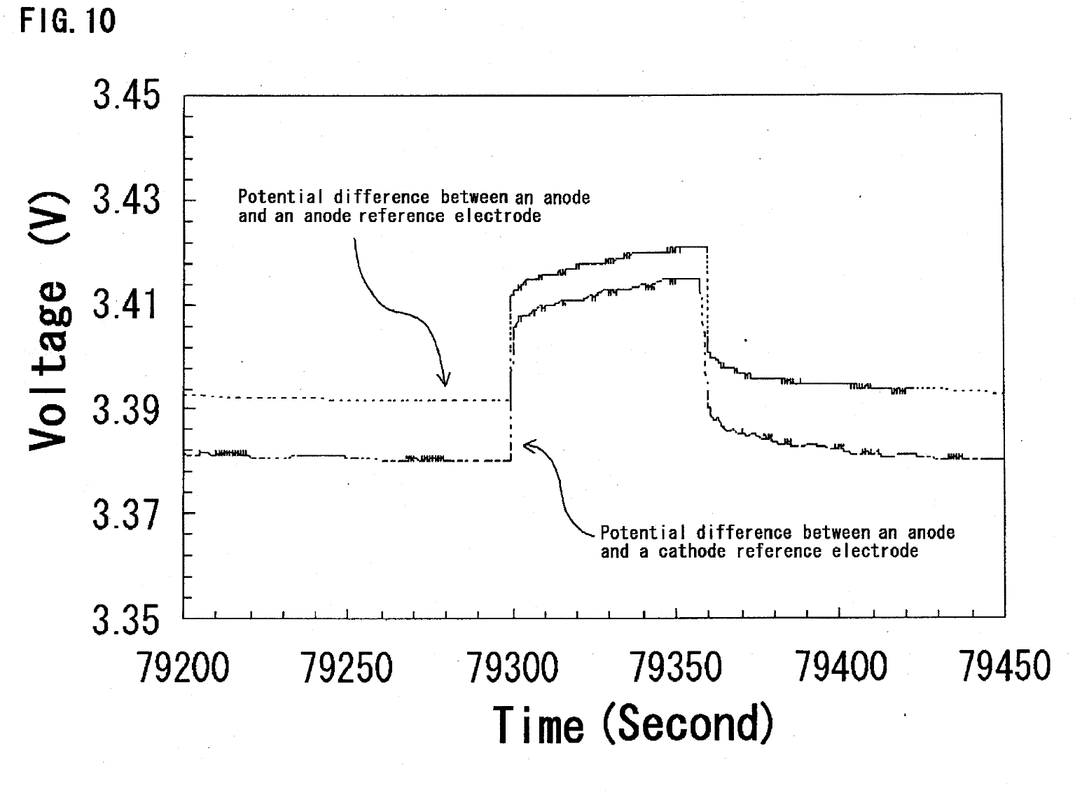

Also with regard to the sample of the comparative example 1, the inner resistance of the direct current is evaluated based on the same charge and discharge cycle experiment as in the example 1. FIG. 10 shows the time change characteristic (charge and discharge curve) between the following potential differences; the obtained potential difference between the anode-anode reference electrode (V+R+) in the discharging rest point B1, and the potential difference between the anode-cathode reference electrode (V+R−). In the charge and discharge curve in the figure, the convex portion above shows the potential at the time of the 60 second-current rest. The average differential between the potential difference curve (V+R+) and the potential difference (V+R−) at the time of the 60 second-current rest is 6.3 mV. The curves of the potential difference (V+R+) and the potential difference (V+R−) do not overlap each other. This is because there is no IR drops made from the resistance R of the separator and the electrolyte which exist between the anode reference electrode and the cathode reference electrode, when the current does not flow. Thus, the anode potential is incorrectly indicated.

### —Evaluation on Comparative Example 2—

Also with regard to the sample of the comparative example 2, the inner resistance of the direct current is evaluated based on the same charge and discharge cycle experiment as in the example 1. The illustration of the obtained discharge curve is omitted. After measuring the potential difference between the anode-anode reference (V+R+) and the potential difference between anode-cathode reference (V+R−) in the discharging rest B1, the average differential between the potential differences (V+R+) (V+R−) at the time of the 60 second-current rest is 5.7 mV. For that reason, when the core material 11 of the reference electrode 10 is set to have a diameter more than 70 micrometer, the anode potential is likely to incorrectly be indicated.

### —Evaluation on Comparative Example 3—

Also with regard to the sample of the comparative example 2, the inner resistance of the direct current is evaluated based on the same charge and discharge cycle experiment as in the example 1. The illustration of the obtained discharge curve is omitted. After measuring the potential difference between anode-anode reference (V+R+) in the discharging rest B1 and the potential difference between anode-cathode reference (V+R−), the average differential between the potential differences (V+R+) (V+R−) at the time of the current rest for 60 seconds is 5.2 mV. For that reason, when the lithium membrane 12 has the thickness more than 50 micrometer, the anode potential is incorrectly indicated.

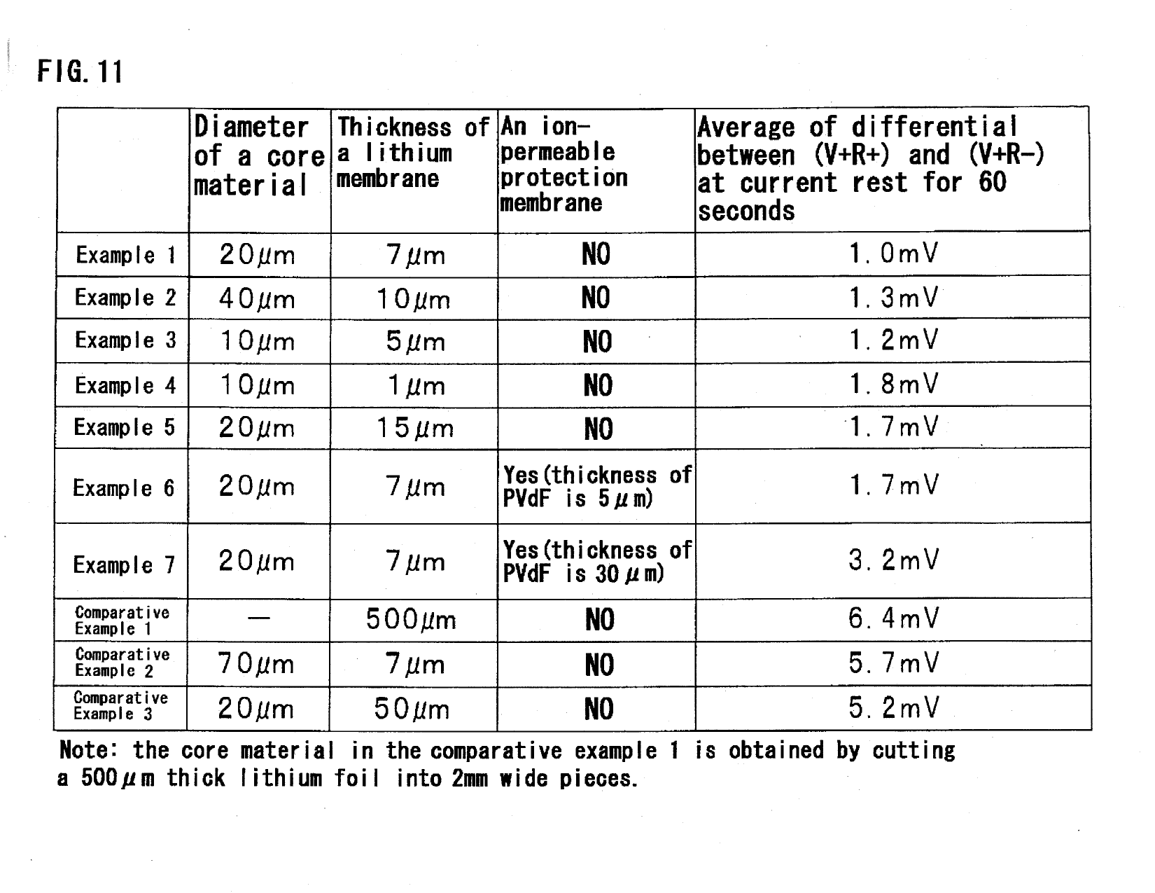

FIG. 11 shows a table about the sample structures for the Examples 1-7, about the comparative examples 1-3, and, also about the average differential between the potential difference (V+R+) and the potential difference (V+R−) at the time of the 60 second-current rest.

### INDUSTRIAL APPLICABILITY

The present invention can be used for power units such as a cellular phone, a notebook computer, a hybrid car, and an electric vehicle, and used for electrochemical cell such as lithium rechargeable battery installed in uninterruptible power supply.

### DESCRIPTION OF SYMBOLS

A . . . electrochemical cell
10 . . . reference electrode
10a . . . anode reference electrode (working pole reference electrode)
10b . . . cathode reference electrode (counter pole reference electrode)
11 . . . core material
12 . . . lithium membrane
13 . . . insulator
14 . . . anode (working pole)
15 . . . anode tab.
16 . . . cathode (counter pole)
17 . . . cathode tab.
18a . . . separator
18b . . . separator
19 . . . battery container
20 . . . ion permeable protection film (ion permeable substance film)

What is claimed:

1. A method of manufacturing a reference electrode arranged in an area between a working pole and a counter pole in an electrochemical cell,
wherein the reference electrode comprises a core material, and a lithium membrane consisting of lithium or lithium alloy which covers at least in part of the core material,
wherein at least a surface of the core material is a conductive material which does not substantially react to lithium or lithium alloy, and
the method comprising forming the lithium membrane by using a vacuum evaporation method or an electrolytic deposition method.

2. The method of manufacturing the reference electrode according to claim 1,
wherein the core material comprises a central part consisting of a steel wire, and a surface consisting of a conductive material which does not substantially react to the lithium or the lithium alloy covering the central part of the core material, and
wherein an outer surface of the lithium membrane is coated with a membrane of an ion-permeable substance which has waterproofness but substantially does not have electron conductivity.

3. The method of manufacturing the reference electrode according to claim 1,
wherein a maximum width in a cross section of the core material is in the range of not less than 5 micrometers but not more than 50 micrometers.

4. The method of manufacturing the reference electrode according to claim 1,
wherein at least the surface of the core material substantially has a resistance to an electrolyte of the electrochemical cell.

5. The method of manufacturing the reference electrode according to claim 3,
wherein at least the surface of the core material substantially has a resistance to an electrolyte of the electrochemical cell.

6. The method of manufacturing the reference electrode according to claim 1,
wherein the conductive material constituting at least the surface of the core material consists of a stainless steel or a stainless alloy.

7. The method of manufacturing the reference electrode according to claim 4,
wherein the conductive material constituting at least the surface of the core material consists of a stainless steel or a stainless alloy.

8. The method of manufacturing the reference electrode according to claim 3,
wherein the conductive material constituting at least the surface of the core material consists of a stainless steel or a stainless alloy.

9. The method of manufacturing the reference electrode according to claim 5,
wherein the conductive material constituting at least the surface of the core material consists of a stainless steel or a stainless alloy.

10. The method of manufacturing the reference electrode according to claim 1,
wherein the core material comprises a central part consisting of a steel wire, and a surface consisting of a conductive material which does not substantially react to the lithium or the lithium alloy covering the central part of the core material.

11. The method of manufacturing the reference electrode according to claim 3,
wherein the core material comprises a central part consisting of a steel wire, and a surface consisting of a conductive material which does not substantially react to the lithium or the lithium alloy covering the central part of the core material.

12. The method of manufacturing the reference electrode according to claim 4,
wherein the core material comprises a central part consisting of a steel wire, and a surface consisting of a conductive material which does not substantially react to the lithium or the lithium alloy covering the central part of the core material.

13. The method of manufacturing the reference electrode according to claim 5,
wherein the core material comprises a central part consisting of a steel wire, and a surface consisting of a conductive material which does not substantially react to the lithium or the lithium alloy covering the central part of the core material.

14. The method of manufacturing the reference electrode according to claim 6,
wherein the core material comprises a central part consisting of a steel wire, and a surface consisting of a conductive material which does not substantially react to the lithium or the lithium alloy covering the central part of the core material.

15. The method of manufacturing the reference electrode according to claim 7,
wherein the core material comprises a central part consisting of a steel wire, and a surface consisting of a conductive material which does not substantially react to the lithium or the lithium alloy covering the central part of the core material.

16. The method of manufacturing the reference electrode according to claim 8,
wherein the core material comprises a central part consisting of a steel wire, and a surface consisting of a conductive material which does not substantially react to the lithium or the lithium alloy covering the central part of the core material.

17. The method of manufacturing the reference electrode according to claim 1, further comprising an insulator partially coating a field uncoated with the lithium membrane in the core material.

18. The method of manufacturing the reference electrode according to claim 3, further comprising an insulator partially coating a field uncoated with the lithium membrane in the core material.

19. The method of manufacturing the reference electrode according to claim 4, further comprising an insulator partially coating a field uncoated with the lithium membrane in the core material.

20. The method of manufacturing the reference electrode according to claim 5, further comprising an insulator partially coating a field uncoated with the lithium membrane in the core material.
